(19) United States
(12) Patent Application Publication
(10) Pub. No.: US 2012/0138712 A1
(43) Pub. Date: Jun. 7, 2012

(54) INJECTOR FOR VEHICLE

(75) Inventor: Chang Yeol Choi, Yongin-si (KR)

(73) Assignee: Hyundai Motor Company, Seoul (KR)

(21) Appl. No.: 13/213,839

(22) Filed: Aug. 19, 2011

(30) Foreign Application Priority Data
Dec. 2, 2010 (KR) 10-2010-0122237

(51) Int. Cl. B05B 1/30

(52) U.S. Cl. 239/584

(57) ABSTRACT

An injector for a vehicle includes an acceleration passage and at least two expansion passages formed in a nozzle hole such that the acceleration passage increases flow of fuel and the expansion passage increases mixing rate of the fuel and air by generating bubbles in the fuel. The injector for a vehicle may include a housing of cylindrical shape, a plurality of nozzle holes communicating an inside of the housing with an outside thereof at a lower end portion of the housing, and a needle adapted to move reciprocally in the housing, and selectively opening or closing the nozzle hole, wherein each nozzle hole is provided with an acceleration passage and at least two expansion passages, and diameters of the acceleration passage and at least two expansion passages are linearly increases, decreased, or maintained, respectively.

### CROSS-REFERENCE TO RELATED APPLICATION

This application claims priority to and the benefit of Korean Patent Application No. 10-2010-0122237 filed Dec. 2, 2010, the entire contents of which application is incorporated herein for all purposes by this reference.

### BACKGROUND OF INVENTION

1. Field of Invention

The present invention relates to an injector for a vehicle. More particularly, the present invention relates to an injector for a vehicle in which an acceleration passage and at least two expansion passages are formed in a nozzle hole such that the acceleration passage increases flow of fuel and the expansion passage increases mixing rate of the fuel and air by generating bubbles in the fuel.

2. Description of Related Art

Generally, vehicles are divided into diesel vehicles directly injecting fuel into a combustion chamber and gasoline vehicles injecting fuel into intake passage or intake manifold and supplying air-fuel mixture to a combustion chamber through intake valves.

In a case of the gasoline vehicle, the injected fuel is supplied to the combustion chamber through the intake valve after being sufficiently mixed with the air at the intake passage or the intake manifold. Therefore, fuel spray characteristics are little important.

In a case of the diesel vehicle, however, the fuel is directly injected to the combustion chamber through an injector and is burned therein. Therefore, it is hard to take a sufficient time for the fuel to be mixed with the air. Thus, fuel spray characteristics are very important in a case of the diesel vehicle, and have a great effect on combustion characteristics.

The spray characteristics of the fuel is greatly related to a cross-sectional shape of a nozzle hole of the injector. One of various factors which define the cross-sectional shape of the nozzle hole is K factor. The K factor is defined as follows.

K factor=(dᵢₙ−dₒᵤₜ)/10

Herein, dᵢₙ denotes an inlet diameter of the nozzle hole, and dₒᵤₜ denotes an outlet diameter of the nozzle hole.

If the K factor is small, penetration length is shortened but spray spreads widely. If the K factor, on the contrary, is large, the penetration length becomes longer but spray spreads narrowly. That is, if the fuel is injected through nozzle hole having small K factor, the air and the fuel are mixed well and emission may be reduced at a partial-load region, but the penetration length is short and output becomes reduced at a high-load region at which injection amount of the fuel is large.

On the contrary, if the fuel is injected through the nozzle hole having large K factor, the penetration length becomes longer but the spray spreads narrowly. Therefore, the output may be increased, but the air and the fuel are not mixed well.

As described above, if the K factor of the nozzle hole having only one increasing rate or decreasing rate of the diameter is controlled so as to improve combustion characteristics, there are merit and drawback. Therefore, the nozzle hole having at least two change rate of the diameter has been researched.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an injector for a vehicle having advantages of increasing flow of fuel and mixing rate of the fuel and air by using a nozzle hole having an acceleration passage and at least two expansion passages.

An injector for a vehicle according to various aspects of the present invention may include a housing of cylindrical shape, a plurality of nozzle holes communicating an inside of the housing with an outside thereof at a lower end portion of the housing, and a needle adapted to move reciprocally in the housing, and selectively opening or closing the nozzle hole, wherein each nozzle hole is provided with an acceleration passage and at least two expansion passages, and diameters of the acceleration passage and at least two expansion passages are linearly increases, decreased, or maintained, respectively.

At least two expansion passages may include a first expansion passage having an increasing diameter, and a second expansion passage having a constant diameter.

The acceleration passage and the first and second expansion passages may be disposed in a sequence of the acceleration passage, the first expansion passage, and the second expansion passage from the inside of the injector to the outside thereof.

Increasing rate of the diameter of the first expansion passage may be larger than decreasing rate of the diameter of the acceleration passage.

K factor of the nozzle hole may be between −5 and 10.

Boundary between the acceleration passage and the first expansion passage or boundary between the first expansion passage and the second expansion passage may be formed of a curved line.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cross-sectional view of an exemplary injector for a vehicle according to the present invention.

FIG. 2 is an enlarged cross-sectional view of a nozzle hole in an exemplary injector for a vehicle according to the present invention.

FIG. 3 illustrates kinetic energy in a case that fuel is injected through an exemplary nozzle hole according to the present invention and in a case that fuel is injected through a conventional nozzle hole.

FIG. 4 illustrates emission in a case that fuel is injected through an exemplary nozzle hole according to the present invention and in a case that fuel is injected through a conventional nozzle hole.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

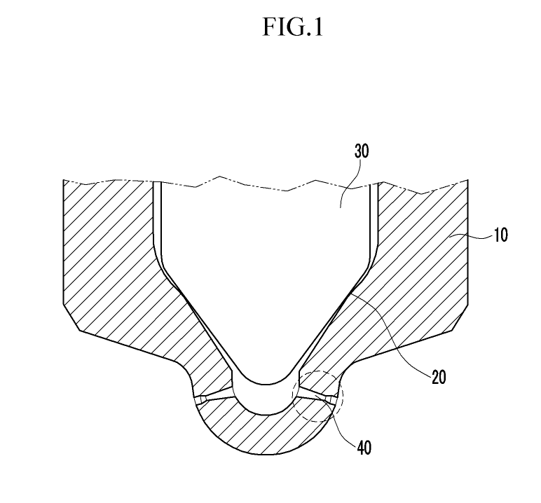

As shown in FIG. 1, an injector according to various embodiments of the present invention is provided with a needle 30 disposed in a housing 10. The needle 30 is adapted to move reciprocally in the housing 10. In order to move the needle 30 reciprocally, an electromagnet is provided at an upper portion of the housing 10. Therefore, if current is applied to the electromagnet the needle 30 moves upwardly, and if current is not applied to the electromagnet the needle 30 moves downwardly so as to contact with a needle seat 20.

In addition, a fuel passage is formed in the housing 10. The fuel passage is always connected to a fuel supply passage formed at an outside of the injector so as to receive fuel.

In addition, a plurality of nozzle holes 40 which penetrates from an inside to an outside of the housing 10 is formed at a lower portion of the housing 10. The plurality of nozzle holes 40 are selectively connected to the fuel passage. That is, if the current is not applied to the electromagnet and the needle 30 contacts with the needle seat 20 formed at the lower portion of the housing 10, the fuel passage and the nozzle hole 40 are not communicated with each other. If the current, on the contrary, is applied to the electromagnet and the needle 30 is parted from the needle seat 20, the fuel passage and the nozzle hole 40 are communicated with each other. At this time, the fuel is injected into a combustion chamber through the nozzle hole 40.

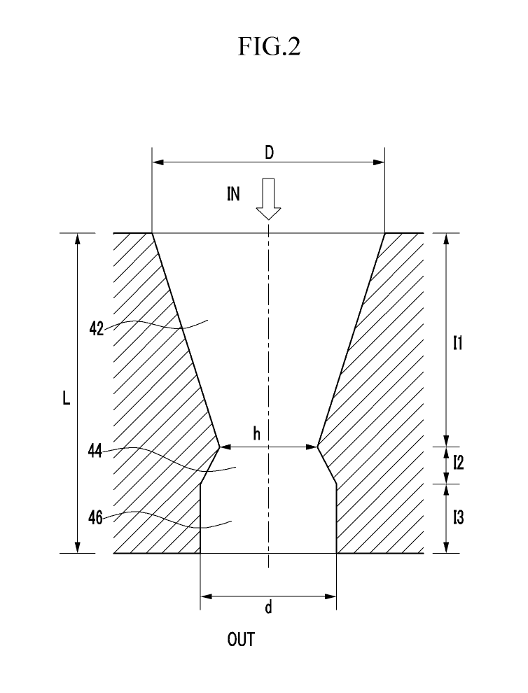

As shown in FIG. 2, the nozzle hole 40 according to various embodiments of the present invention is formed by three passages (i.e., an acceleration passage 42, a first expansion passage 44, and a second expansion passage 46).

The acceleration passage 42 is disposed closest to the inside of the injector 10, the second expansion passage 46 is disposed closest to the outside of the injector 10, and the first expansion passage 44 is disposed between the acceleration passage 42 and the second expansion passage 46.

A diameter of the acceleration passage 42 becomes smaller so as to increase a speed of the fuel passing through the acceleration passage 42. That is, an inlet diameter of the acceleration passage 42 is D, an outlet diameter of the acceleration passage 42 is h, and D is larger than h. In addition, the diameter of the acceleration passage 42 is linearly reduced according to a flow of the fuel. Reduction ratio K1 in the diameter of the acceleration passage 42 is represented as follows.

K1=(D−h)/11

Herein, 11 represents a length of the acceleration passage 42.

By forming the inlet diameter D of the acceleration passage 42 to be large, flow resistance of the fuel at the inlet of the nozzle hole 40 may be reduced. Therefore, flow of the fuel may increase.

The first expansion passage 44 is communicated to the acceleration passage 42, and a diameter of the first expansion passage 44 increases abruptly. Therefore, a volume of the fuel passing through the first expansion passage 44 is abruptly expanded and some fuel may be atomized. Such an atomization promotes mixing of the fuel and the air. In addition, increasing rate of the diameter of the first expansion passage 44 is larger than decreasing rate of the diameter of the acceleration passage so as to promote generation of bubbles.

If an inlet diameter of the first expansion passage 44 is h and an outlet diameter of the first expansion passage 44 is d, the increasing rate of the diameter of the first expansion passage 44 is represented as follows.

K2=(d−h)/12

Herein, 12 represents a length of the first expansion passage 44.

In addition, the diameter of the first expansion passage 44 is linearly increased according to the flow of the fuel.

The second expansion passage 46 is communicated with the first expansion passage 44 and the constant diameter of the second expansion passage 46 is maintained. The second expansion passage 46 further promotes the atomization of the fuel. Accordingly, the atomized fuel and the air are mixed such that mixing rate of the fuel and the air may further increase.

As described above, the nozzle hole 40 accordind to various embodiments of the present invention increases the flow of the fuel and improves mixing rate of the fuel and the air. For this purpose, a K factor of the nozzle hole 40 should be set optimally. The K factor of the nozzle hole 40 according to various embodiments of the present invention may be disposed between −5 and 10. The K factor of the nozzle hole 40 according to various embodiments of the present invention is represented as follows.

K factor=(D−d)/10

Meanwhile, in order not to prevent the flow of the fuel, a boundary between the acceleration passage 42 and the first expansion passage 44 or a boundary between the first expansion passage 44 and the second expansion passage 46 may be formed of a curved line.

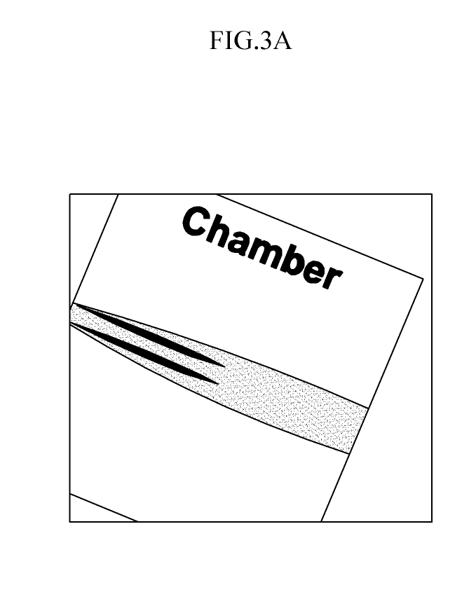

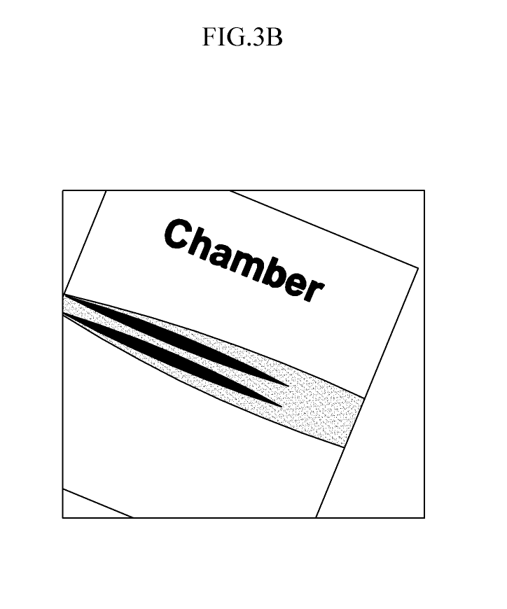

FIG. 3A illustrates a case that the fuel is injected through a conventional nozzle hole, and FIG. 3B illustrates a case that the fuel is injected through the nozzle hole 40 according to various embodiments of the present invention.

Comparing FIG. 3B with FIG. 3A, kinetic energy of the injected fuel is high. High kinetic energy of the injected fuel means that flow of the fuel is large and more turbulence occurs in the fuel. That is, if the fuel is injected through the nozzle hole 40 according to various embodiments of the present invention, the flow of the fuel is large so as to increase output and the fuel is mixed with the air well so as to reduce emission.

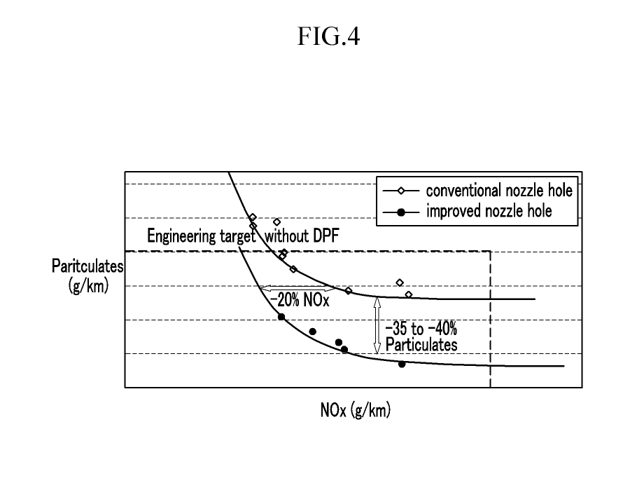

In FIG. 4, an upper curved line represents particulates and nitrogen oxide generated when the fuel is injected through a conventional nozzle hole, and a lower curved line represents particulates and nitrogen oxide generated when the fuel is injected through the nozzle hole 40 according to various embodiments of the present invention.

Compared with the case in which the fuel is injected through a conventional nozzle hole, nitrogen oxide amount is reduced by 20% at the most and particulates are reduced by 35-40% at the most in the case that the fuel is injected through the nozzle hole 40 according to various embodiments of the present invention.

As described above, since flow of fuel is increased at an acceleration region and bubbles are generated so as to increase mixing rate of fuel and air at an expansion region, output may increase and exhaust may be improved according to various embodiments of the present invention.

For convenience in explanation and accurate definition in the appended claims, the terms upper or lower, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to snake and utilize various exemplary embodiments of the present invention, as well as various alternatives and modifications thereof. It is intended that the scope of the invention be defined by the Claims appended hereto and their equivalents.

What is claimed is:

1. An injector for a vehicle, comprising:
a housing having a cylindrical shape;
a plurality of nozzle holes communicating an inside of the housing with an outside at a lower end of the housing; and
a needle reciprocally moveable in the housing that selectively opens and closes the nozzle holes,
wherein each nozzle hole is provided with an acceleration passage and at least two expansion passages, and whereby diameters of the acceleration passage and at least two expansion passages are linearly increased, decreased, or maintained, respectively.

2. The injector of claim 1, wherein at least two expansion passages comprise:
a first expansion passage having an increasing diameter; and
a second expansion passage having a constant diameter.

3. The injector of claim 2, wherein the acceleration passage and the first and second expansion passages are disposed sequentially, first the acceleration passage, the first expansion passage, and the second expansion passage from the inside of the injector to the outside thereof.

4. The injector of claim 3, wherein an increasing rate of the diameter of the first expansion passage is larger than a decreasing rate of the diameter of the acceleration passage.

5. The injector of claim 2, wherein K factor of the nozzle hole is between −5 and 10.

6. The injector of claim 3, wherein boundary between the acceleration passage and the first expansion passage or boundary between the first expansion passage and the second expansion passage is formed as a curved line.
